(19) United States
(12) Patent Application Publication
(10) Pub. No.: US 2008/0285881 A1
(43) Pub. Date: Nov. 20, 2008

(54) Adaptive Image De-Noising by Pixels Relation Maximization

(76) Inventor: Yaniv Gal, Haifa (IL)

Correspondence Address: Pearl Cohen Zedek Latzer, LLP, 1500 Broadway, 12th Floor, New York, NY, 10036, US

(21) Appl. No.: 11/883,513

(22) PCT Filed: Feb. 7, 2006
(86) PCT No.: PCT/IL06/00151

§ 371 Date: Jul. 2, 2008

Related U.S. Application Data
(60) Provisional application No. 60/649,917, filed on Feb. 7, 2005.

(51) Int. Cl. H04N 9/67

(52) U.S. Cl. 382/261; 382/128

(57) ABSTRACT

A method is disclosed for adaptive filtering of at least one pixel having an initial value of an image composed of pixels. The method comprises: calculating local expected value for the pixel; calculating local signal to noise ratio; calculating local filtration ratio based at least on said local signal to noise ratio; calculating a weighted average of the initial value and local expected value using said local filtration ratio as weight; and assigning the weighted average as a new value for the pixel.

### FIELD OF THE INVENTION

The present invention is related generally to the field of image enhancement, and more particularly, to a method of noise reduction, suitable for use in various imaging techniques (for example, but not only, medical nuclear imaging), in order to reduce the noise in the acquired image while preserving fine features in said image.

### BACKGROUND OF THE INVENTION

Sometimes image data acquired contains noise which has to be filtered out to improve the signal. For example, in nuclear medical imaging such as planar imaging and Single Photon Emission Computerized Tomography (SPECT), the acquired image is dominated by statistical noise caused by the random nature of nuclear emission and detection. The Signal to Noise Ratio (SNR) increases with the increasing number of counted photons, but finite acquisition time, which is limited by patient discomfort, sets a limit to the photon counts and causes noisy images. Similar behavior and similar noise statistics exist in other photon imaging methods such as Positron Emission Tomography (PET), Computed Tomography (CT), etc. Generally, this type of counting noise is known at “Shot Noise” and is described by a Random-Markov-Field, with a positive, unknown neighborhood dependency size.

Other types of medical and non-medical imaging techniques such as Magnetic Resonance Imaging (MRI), Ultrasound, applications and instruments for night vision, telescopes and microscopes also result in noisy images. Low pass filtering of a noisy image reduces the noise but also reduces the signal in the data by suppressing high frequency components within the data. Typically, filtering methods known in the art are based on frequency domain filtering. In these methods, the filter is crafted to suppress the frequencies where the data is dominated by noise while retaining or even enhancing the frequencies where the data is dominated by signal. For example, Fourier Transform is used to convert an image from its spatial pixel representation into its frequency domain representation, where low-pass filtering is done by multiplying high frequency components by a small number. The filtered frequency representation is then transformed back into spatial pixel representation using inverse Fourier transform. It can be mathematically shown that convolving the original data with the respective spatial filter can do the same operation.

Although these filtering techniques are very useful, they nevertheless smooth out sharp features in the image, causing information loss.

A description of adaptive & linear filtering techniques can be found in the following papers:
[1] C. Tomasi, R. Manduchi, “Bilateral Filtering for Grey and Color Images” in ICCV, 1998.
G. Winkler, V. Aurich, K. Hahn, A. Martin & K. Rodenacker, “Noise Reduction in Images: Some Recent Edge-Preserving Methods”,1999.

### SUMMARY OF THE INVENTION

Accordingly, it is a principle object of the present invention to overcome the disadvantage of prior art methods. In prior art methods, filters consider dependency between neighboring pixels due to the convolving nature of the projection of the data to the detector or due to the correspondence between neighboring pixels intensity. These methods, do not adaptively account for the level of reliability of the data in a pixel and its neighborhood. In the inventive method of the current invention smoothing the data is stronger where the data is dominated by noise while less smoothing is done where the data is dominated by signal.

It should be appreciated that in natural images such as images acquired by nuclear imaging camera, the signal amplitude at low frequencies is usually much higher than the amplitude at high frequencies. This is specifically true for nuclear medicine images acquired by a gamma camera equipped with a collimator such as in planar imaging or SPECT as the relatively large acceptance angle of the collimator acts as a low-pass filter that smears the original image. Further more, it can be safely assumed that the highest frequencies in the signal relate to noise in the image.

From the above assumptions one can conclude that variations in the image, which are not across edges, will usually be small. Hence, when encountering large variations in the acquired image, which are not across edges, one can assume that these variations are related to noise, rather than to a structure in the original image.

Accordingly, it is an objective of the present invention to minimize the variations in the image, which are not present across edges and to preserve the variations, which are present across edges.

It is thus a step in the current inventive method to quantify local SNR associated with each location in the data and adapt the local filtering according to the local SNR.

In order to quantify the local SNR associated with each locality in the image, both signal measure for the noise level and signal content associated with the region of interest within the image have to be estimated.

In nuclear emission imaging as well as in other photon counting imaging devices the noise is known as “Shot Noise” and is described by a Random-Markov-Field, with a positive, unknown neighborhood dependency size. Such noise dominates night vision cameras based on amplification of available starlight and other low signal level imaging devices.

In these devices, the level of noise in a pixel is essentially proportional to the square root of the intensity measured at that pixel. Thus, a measure of the noise content in each pixel can be estimated from the datum itself. Optionally, the square root of a local mean pixel value in the near neighborhood of a pixel may be used to estimate the noise.

Another way to estimate the noise level is to filter out the signal from the data by performing high-pass filtration and then calculating the Standard Deviation (SD) of the noise dominated remainder. The local SD, calculated from the high-passed filtered image, in a neighborhood around a specific pixel can be used as a measure of the local noise. The global SD, calculated from the entire high-passed filtered image, can be used as a measure of the global noise in the image.

A way to estimate the signal level associated with a locality within an image is to calculate the SD in a neighborhood of this locality. Since it is assumed that the highest frequencies are dominated by random noise, the data may optionally be smoothed to remove this noise.

It should be appreciated that the neighborhoods used for the estimation of local noise and local signal may not be identical, and the frequency cutoffs optionally used for the high-pass and low-pass may be different.

The resulting local SNR associated with each locality within the image may then be used to determine the smoothing done at each said locality.

Said smoothing is generally spatial low pass filtering done by replacing the value of image datum with some estimation of expected value of data in the neighborhood of said locality. Said expected value may be a simple or weighted average of the values in the neighborhood, median value of the neighborhood, etc.

These and other objects and advantages in accordance with the present invention will become more readily apparent from a consideration of the ensuing description, claims, and accompanying drawings.

Further features and advantages of the invention will be apparent from the drawings and the description contained herein.

### BRIEF DESCRIPTION OF THE DRAWINGS

An exemplary embodiment of the invention is described in the following section with respect to the drawings. The same reference numbers are used to designate the same or related features on different drawings. The drawings are generally not drawn to scale.

FIG. 1 is a schematic block diagram of adaptive image filter, according to an exemplary embodiment of the invention.

FIG. 2 is a schematic block diagram of adaptive image filter, according to another exemplary embodiment of the invention.

FIG. 3. is an illustration of a system according to an exemplary embodiment of the invention.

### DETAILED DESCRIPTION OF PREFERRED EMBODIMENTS

The following detailed description is of the best presently contemplated modes of carrying out the present invention. This description is not to be taken in a limiting sense, but is made merely for the purpose of illustrating the general principles in accordance with the present invention. The scope of the present invention is best defined by the appended claims.

The following description of the invention is illustrated for a two-dimensional image made of pixel arrange in a Cartesian x and y dimensions. The method, however, is not limited and may be applied to data arranged in other ways.

Definitions

We define:

I-The acquired (noisy) image.

I_{x,y}-The intensity of the pixel in position (x,y) of the acquired noisy image.

M_{x,y}-The intensity expected value in the neighborhood of the pixel (x,y).

For example, M_{x,y} is optionally a local weighted average in the neighborhood of the x,y pixel as given by:

$${M}_{x , y} = \frac{1}{W} {\sum }_{\begin{matrix}X = - Nx \\ Y = - Ny\end{matrix}}^{\begin{matrix}X = Nx \\ Y = Ny\end{matrix}} {I}_{x + X , y + Y} {w}_{X , Y}$$

Where w_{X,Y} are the weights defining the weighted average.

The neighborhood in this example is a rectangular tile of (2Nx+1)*(2Ny+1) pixels centered at (x,y)

If the total counts in the image is to be conserved, the factor W may be defined as:

$$W = {\sum }_{\begin{matrix}X = - Nx \\ Y = - Ny\end{matrix}}^{\begin{matrix}X = Nx \\ Y = Ny\end{matrix}} {w}_{X , Y}$$

In the preferred embodiment, M_{x,y} is calculated by simple averaging of 3×3 pixels tile around the pixel (x,y) Nx=Ny=1 and w_{X,Y=}1/9

For very noisy images, on the other hand, one may prefer to take a bigger neighborhood size, in order to achieve a more reliable value for M_{x,y}.

Alternatively, M_{x,y} may be calculated to be the median pixel value in the neighborhood of the pixel (x,y)

Alternatively, M_{x,y} may be calculated to be the local average or local weighted average of neighboring pixel values with respect to pixel (x,y) after outlayer values in said neighborhood were removed (like alpha pruning).

For example, the T_{L} lowest and T_{H} highest values in the neighborhood are eliminated, and the mean value of the rest is calculated, using the result as M_{x,y}.

A variation on this method can be to eliminate any value which is away from the mean by more than a specific value, or away from the mean by more than a specific fraction of the mean or away from the mean by more than a specific constant times the standard deviations and then recalculate the mean value.

Near the image edges, data padding may be done. For example, setting the value of the non existing datum I_{x<0, y} with the value I_{0,y}, and similarly for all datum around the image edges such as x>xₘₐₓ, y<0, etc. Alternatively, the neighborhood of a pixel near the image edge may be defined to be smaller than that of a pixel at the center of the image such that the neighborhood of a pixel near the image edge contains only pixels that actually exist in the image.

S_{x,y}-The intensity Standard Deviation in the neighborhood of the pixel (x,y).

$$. i . e . {S}_{xy} = \sqrt{{\sum }_{\begin{matrix}{x}^{′} = - N \\ {y}^{′} = - {N}_{y}\end{matrix}}^{\begin{matrix}{x}^{′} = N \\ {y}^{′} = {N}_{y}\end{matrix}} {( {I}_{{x}^{′} {y}^{′}} - {M}_{xy} )}^{2}}$$

Generally speaking, S_{x,y} should be larger for a neighborhood which contains edges and smaller for a neighborhood in which the intensity is more homogeneous (no edges are present)

This neighborhood may be different than the neighborhood used for Mx,y.

Optionally, the data in the neighborhood is filtered before calculating the local SD using a low-pass filter to reduce the effect of random noise on S_{x,y}.

Optionally, Sx,y may be calculated for a pixel (x,y) from a weighted neighborhood in which I_{x,y} is replaced by V_{X-x,Y-y}*I_{x,y}, where V_{a,b} are the weights.

Optionally, S_{x,y} may be a function of the norm of the gradient at position (x,y).

Optionally, S_{x,y} may be a function of the “Shannon's Entropy” estimator.

Optionally, S_{x,y} may be a function of the correlation between the gradient at pixel (x,y) and it's neighbor gradients

Optionally S_{x,y} may be any linear or non-linear combination of the above.

N—An estimation of the global noise level, calculated for the entire image.

In some embodiment of the invention, N is estimated by calculating the global SD for the entire image. Optionally, the data in the image is filtered before calculating the global SD using high-pass filter.

N_{x,y} is the estimation for the local noise level for pixel (x,y).

In one embodiment, estimation for N_{x,y} is by calculation of SD of high-pass filtered neighborhood around pixel (x,y). This neighborhood may be different than the neighborhood used for M or S. Optionally the data may be weighted.

In another embodiment, N_{x,y} is given by the square root of the pixel value according to N_{x,y}=(I_{x,y})^{1/2}

In yet another embodiment, N_{x,y} is given by the square root of the mean pixel value according to N_{x,y}=(M_{x,y})^{1/2} or N_{x,y}=(M′_{x,y})^{1/2}, where M′_{x,y} is a mean pixel value calculated using different method of local smoothing such as using different size neighborhood, different weights etc.

In the preferred embodiment, N_{x,y} is calculated as:

N_{x,y}=\sqrt{M_{x,y}}

Let SNR_{x,y} be the estimation of the local signal to noise ratio at pixel (x,y).

In the preferred embodiment, SNR_{x,y} is given by: SNR_{x,y}=M_{x,y}/N_{x,y}

It should be recognized that the estimation of SNR_{x,y} is itself noisy, thus limits (min & max) may optionally be set for its values. Alternatively or additionally, smoothing or averaging may be applied to SNR_{x,y}. Alternatively, optionally separate limits or smoothing are applied to each of S_{x,y} .or N_{x,y}.

Another way to understand this embodiment inventive method is to appreciate the fact that the amount of information in a pixel is affected by the amount of information in its neighbors. Hence, we assume that M_{x,y} is a better estimation of the expected value of I_{xy}. Since the source of I_{xy} follows a Poisson distribution, the estimated SNR of I_{xy} is

$$\frac{{M}_{xy}}{\sqrt{{M}_{xy}}} = \sqrt{{M}_{xy}} .$$

Edges of structures in the image, which increase the calculated SD in a neighborhood of a given pixel (Sx,y), may contribute some information about the structure of the neighborhood of that pixel. From the above we chose to use the following representation for the SNRxy:

$${SNR}_{xy} = \frac{{S}_{xy} \cdot {M}_{xy}}{\sqrt{{M}_{xy}}} = {S}_{xy} \cdot \sqrt{{M}_{xy}}$$

Note that here SNR_{xy} is not representing the Signal-to-Noise-Ratio in its common meaning but an estimation for the reliability of the information in the pixel (x,y).

For a given image it is preferable to “normalize” this value according to the global noise level, so different images will eventually contain the same amount of noise after the filtering process and will thus have similar quality.

Since features in the image are generally clustered near the edges of the object to be imaged, it is optionally advantageous to analyze SNR_{x,y}. For example, SNR_{x,y} may optionally be replaced by the maximum value in its neighborhood in order to enhance resolution in the vicinity of image structures.

Filtration

When the local SNR_{x,y} in the image is low, filter should favor the local mean value M_{x,y} over the original value, I_{x,y} as the new pixel's value. On the other hand, when the local SNR is high, we assume that an edge is present and we would like the filter to preserve the original pixel's value, I_{x,y}.

A filter functional, satisfying the above conditions, can be written in the following way:

F(I_{x,y})=G_{x,y}I_{x,y}+(1−G_{x,y})M_{x,y}

Where generally G_{x,y} is the filtration factor having values between 0 and 1, and is a function of SNR_{x,y} (and thus a function of Sx,y and Nx,y) and is monotonously decreasing with Nx,y and monotonously increasing with Sx,y.

In the preferred embodiment G_{x,y} is given by:

$${G}_{x , y} = exp ( - \frac{C ( I )}{{SNR}_{x , y}} ) = exp ( - \frac{N \cdot a}{{S}_{x , y} \cdot \sqrt{{M}_{x , y}}} )$$

Where C(I) is a normalization function and a is the filter parameter which controls the image sharpness, described below.

Clearly, the above example of G_{x,y} obeys the requirements as it approaches zero when the noise level is high or when the local standard deviation is small, and it approaches one when the opposite is true.

From the above formulation we can see that one may choose different values for F in order to achieve different sharpness levels for the filter. The higher the values of F, the “smoother” the resultant image will be, relative to the source, regardless of the local conditions of the pixel. In the preferred embodiment, a reasonable choice for F will be a value between 0 and 1.

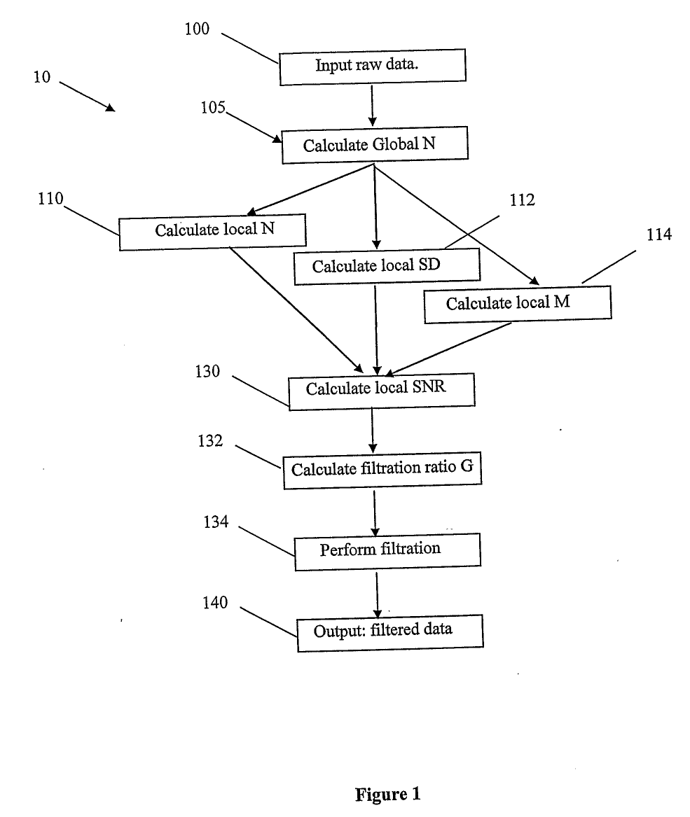

With reference to the drawings, FIG. 1 is a schematic block diagram of adaptive image filter, according to an exemplary embodiment of the invention.

The method 10 according to the current invention is operating on received input data 100. Input data may be raw data acquired by a data acquisition system such as a gamma camera or may be data already processed such as reconstructed SPECT image, or other type of data. Alternatively the filter's mathematical model can be plugged into an optimization algorithm aimed to reconstruct an image from the data when a model for the projection process is given or as a regularization function of other iterative filtering methods

In step 105 the global noise level in the image is being calculated.

In steps 110 and 122, the noise level and signal content. N_{x,y} and S_{x,y} are determined respectively according to the above definitions.

In step 114 the local signal to mean pixel value M_{x,y} .is calculated.

In step 130 the local signal to noise SNR_{x,y} .is calculated. Said SNR_{x,y} is used for calculation of filtration ratio G_{x,y} .in step 132.

Said G_{x,y} is used for calculation of filtration ratio G_{x,y} .in step 132.

Finally, in step 140 the filtered data is returned to be displayed or to be further processed.

Extension to Other Dimensionalities

Although the exemplary embodiment was demonstrated using two-dimensional notation, it should be clear to a person skilled in the art that one-dimensional or higher dimensionality data may be filtered using the inventive method.

This is simply done by replacing I_{x,y} with Iᵥ where v is a vector of any dimension (multi-dimensional).

Similarly, Mᵥ, Sᵥ, etc. are defined.

In this case the calculation of intensity sums in a pixel's neighborhood are performed over the relevant dimensions.

for example:

$${M}_{v} = \frac{1}{W} {\sum }_{V = - V 0}^{V = V 0} {I}_{v + V} {w}_{V}$$

Where v and V have same dimensionality.

It should be clear that dimensions could be of different nature. For example, one the dimensions could be a spatial coordinate while another dimension could be the time. Example for such situation could be filtration of video images where two dimensions ate spatial coordinates and one is the time sequence.

It should be clear that the neighborhood of a pixel may span different number of pixels in each dimension and possibly the neighborhood may be non-symmetric.

It should be recognized that there are many ways to carry out the filtering operation according to the current invention. For example, the order of the steps can be altered without affecting the final result.

Rearranging the data and the summation order may shorten the computation time by saving mathematical calculation, saving memory accesses or both.

For example; when input data representing a neighborhood of a pixel is recalled from a computer mass-storage device and is available for the processor, it may be advantageous to calculate both standard deviation and mean for this neighborhood before moving to a next neighborhood.

In another example, given here for a one dimensional case and simple averaging:

$${M}_{v} = \frac{1}{2 n + 1} {\sum }_{V = - n}^{V = n} {I}_{v + V}$$

After calculating one of the local averages Mᵥ, the next local average Mᵥ₊₁ may be calculated by:

$${M}_{v + 1} = {M}_{v} + \frac{1}{2 n + 1} ( {I}_{v + n + 1} - {I}_{v - n} )$$

Where the mathematical simplification is used to reduce the calculation burden.

Since the filtering routine applies the same calculation over and again, it can easily benefit from distributed computing, parallel processing and the use of vector or matrix processors to accelerate the computation.

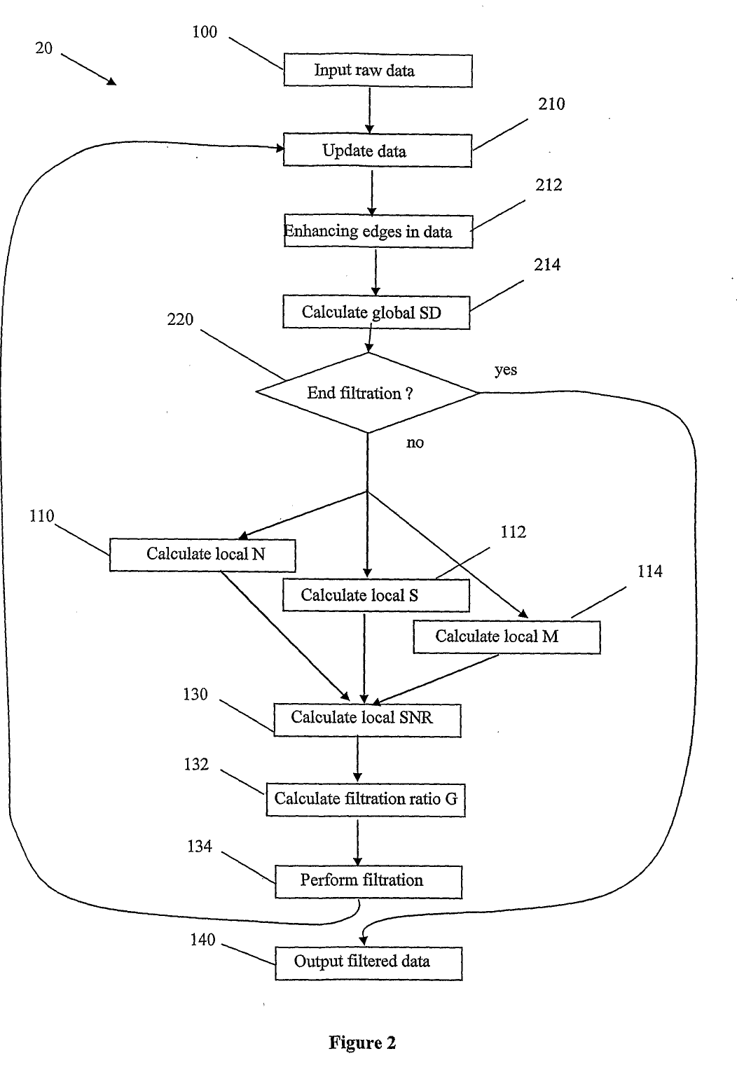

FIG. 2 is a schematic block diagram of adaptive image filter, according to another exemplary embodiment of the invention.

When choosing high values for F the filter might smooth out the image too much and eliminate small details. Low values for F, on the other hand, may not achieve the required de-noising level needed, and will change a pixel value only if both its value and its neighborhood behavior strongly imply that the pixel's value is unreliable.

A way of gaining a little bit from both worlds is by iterating the filter, using low value of F. We define the filtered results of I_{x,y} as I¹_{x,y}=Filtered(I_{x,y}) and define the i^{th} iteration of the filter as Iⁱ_{x,y}=Filtered(Iⁱ⁻¹_{x,y}).

A stopping rule for this method may be an arbitrary choice of the number of iterations or reaching a target value for a global noise level N.

The method 20 according to the current invention is operating on received raw input data 100.

In step 210, the data file is updated. At this stage, the updated data is set to be the input data.

In step 212, the updated data is optionally filtered to enhance edges.

In step 214 optionally the global SD is calculated.

In step 220 it is determined if the stopping criteria for the iterative process is met. Stopping criterion may be a pre-set number of iteration, alternatively or additionally a minimum value for the global noise level N may be set. Optionally other criteria could be used.

It is unlikely that the stopping criteria for the iterations will be satisfied before any filtration was done, thus the updated data is filtered according to the first embodiment of the invention during steps 110, 112, 114, 130, 132, 134.

The filtered data is then returned for another iteration and is used as the updated data in step 210.

When the iteration stopping criteria is met in step 220, the updated data is delivered (step 140) to the output or for further other processing.

Correlated Data

In some cases, a data set is composed of a few correlated data sets. For example, a color image may be composed of three spatially correlated images in the tree basic colors Red, Green and Blue (RGB). Similarly, a sound track is similarly composed of at least left and right tracks. In medical imaging, it becomes increasingly common to correlate registered images acquired in different modalities such as CT and SPECT, etc. In imaging aimed for measuring time evolution of the subject such as dynamic SPECT or stress-rest cardiac imaging plurality of images are taken in time sequence.

In all of these, and other examples, it can be assumes that although the acquired data is different, the features are located in the respective neighborhoods in all the data sets.

Thus it may optionally be advantageous to use information on the location of the features from one data set and use it to determine the filtering to be performed on a second data set.

When one data set is generally of higher image quality than the other, local SNR of the higher quality image may be used for filtering the lower quality image.

For example, CT image of a patient, which is generally of high image quality, may be analyzed to determine the pixels in which organ edges are likely to be found. For example, local SD can be used to map the edges. This map may be optionally used to determine the filtration factor G_{x,y}. Alternatively, this map may be combined with measurements of the SNR_{x,y} to determine the filtration factor G_{x,y}.

As another example, patient body boundaries may be determined by locating the pixels with CT numbers closer to CT number of air. Strong filtration may be applied to these out of body pixels.

When the plurality of data sets are generally of similar image quality such as in a color digital photography, it is optionally advantageous to combine the local SNR of several data sets and use the combination as the images SNR, for filtering of all the data sets.

For example, the highest local SNR for each neighborhood may be used. Alternatively, the average local SNR may be used. Alternately, a majority rule may be used when more than two data sets are available. Alternately other combinations such as non-linear combinations, one example of which is the root-mean-square combination or weighted average may be used.

The effectiveness of the method of noise reduction, according to the present invention was tested by the inventor of the present invention. A synthetic image was created, built up of 4 different gray level areas with sharp boundary between them. A random noise was then added to the image. Two Denoising methods were tested: Denoising with linear filter: In this case the image was smoothed out with minimal amount smoothing (eliminating high frequencies) that still totally eliminates the noise in the image. Denoising with a filter according to the present invention: In this case the image was filtered with a minimal filtering parameter, C, that still eliminates all the noise in the image. The two filtered images were compared. The difference was very clear to the eye: In the image that was filtered by a linear filter the boundaries between the different segments were totally smoothed while in the other image (according to the present invention) the boundaries were kept sharp and clear, almost like in the original image.

A clinical planar image, which was acquired by a gamma camera, was also acquired: Planar images are noisy by nature. In this case the physician performs his clinical diagnosis on the original, noisy, image. Here, also, two Denoising methods were tested: A linear filter was applied on the image, such that the noise in the background is eliminated. A filter according to the present invention was applied with a parameter, C, which caused the noise in the background to be smoothed out. The three images were compared (original and two filtered images): Again, it was clear to the eye that the linear filter eliminated essential details while the filter of the present invention smoothed out the noise in the background while keeping the boundaries in the image sharp.

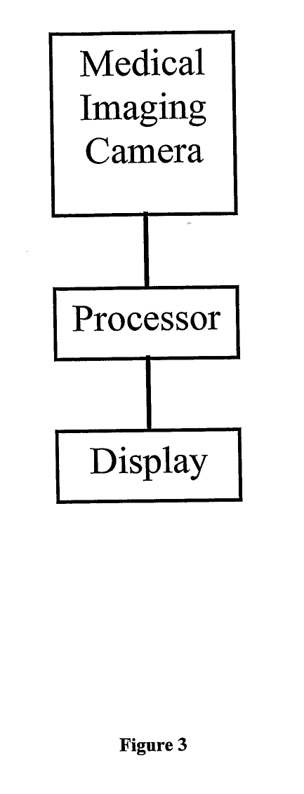

FIG. 3. is an illustration of a system according to an exemplary embodiment of the invention. A medical imaging camera is used to acquire data from a patient. The medical imaging camera may be a nuclear camera capable of acquiring planar or SPECT images, a Positron Emission Tomography (PET) camera, a Computed Tomography (CT) camera, Magnetic Resonance Imaging (MRI) camera, an Ultrasonic imaging device, a digital X-Ray imager, for example general X-Ray imager, a mammography imager or dental imager, EEG recorder, EKG recorder, etc.

Some imaging methods require processing of the raw data. For example, in SPECT, MRI, CT, PET and in other modalities, raw data need processing in order to reconstruct the final image. The processor may be configured to perform the filtering according to the invention on the data before reconstruction.

Alternatively or additionally, filtering my be applied to the reconstructed data before it is displayed. Although the statistical nature of the noise in the raw data may differ from one type of medical imaging camera to another, as well as due to the nature and algorithm used for optionally reconstruct an image from the raw data, the inventive de-noising method may be adopted to wide range of applications.

Alternatively or additionally, filtering my be applied during the reconstruction process. For example, in iterative reconstruction algorithm, filtering may be applied to the intermediate image in at least one of the iteration.

For example, in SPECT imaging, filtering according to the invention my be applied to the projections or to the final reconstructed image. When iterative SPECT reconstruction methods are used such as Maximum Likelihood Expectation Maximization (MLEM) or Ordered Subset Expectation Maximization (OSEM), filtering may be used to the intermediate stages, for example after calculation of next guess.

The processor of FIG. 3. should be viewed in a most general form of a data processing system which process the data acquired by the medical imaging camera and prepare it to be displayed on a display unit. For example, processor may comprise of several signal and data processing units. For example, some of the data processing may be integrated within the medical imaging unit as to be in close proximity to the medical imaging camera while more processing is done in a data processing unit such as a PC located at the same room or remote from the medical imaging camera. Often data is stored and processed or re-processed at later times.

The display unit may be a computer screen, a printer or alike.

While the invention has been described with reference to certain exemplary embodiments, various modifications will be readily apparent to and may be readily accomplished by persons skilled in the art without departing from the spirit and scope of the above teachings.

It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore include structure, acts or details of structures and acts that may not be essential to the invention and which are described as examples. Structure and acts described herein are replaceable by equivalents, which perform the same function, even if the structure or acts are different, as known in the art. Therefore, the scope of the invention is limited only by the elements and limitations as used in the claims.

1. A method for adaptive filtering of at least one pixel having an initial value of an image composed of pixels, the method comprising:
calculating local expected value for the pixel;
calculating local signal to noise ratio;
calculating local filtration ratio based at least on said local signal to noise ratio;
calculating a weighted average of the initial value and local expected value using said local filtration ratio as weight; and
assigning the weighted average as a new value for the pixel.

2. A method as claimed in claim 1, wherein the local filtration ratio is also based on the local expected value of the pixel.

3. A method as claimed in claim 1, wherein the local filtration ratio is also based on the initial value of the pixel.

4. A method as claimed in claim 1, wherein the expected value comprises a local mean value.

5. A method as claimed in claim 1, wherein the expected value comprises a local median.

6. A method as claimed in claim 1, wherein the expected value comprises a local weighted average neighborhood pixel values with respect to the pixel, after outlayer values in said neighborhood were removed.

7. A method as claimed in claim 6, wherein the expected value comprises an alpha-pruning value.

8. A method as claimed in claim 1, wherein the signal to noise ratio comprises a local standard deviation.

9. A method as claimed in claim 1, wherein the signal to noise ratio comprises a local gradient norm at the pixel.

10. A method as claimed in claim 1, wherein the signal to noise ratio comprises a Shannon's Entropy estimator.

11. A method as claimed in claim 1, wherein the signal to noise ratio comprises a correlation between a gradient at the pixel and neighboring gradients.

12. A method as claimed in claim 1, wherein the local filtration ratio is given by the formula G=Exp [−C/SNR] where G is the local filtration ratio, C is constant for the image and SNR is the local signal to noise ratio.

13. A method as claimed in claim 12, wherein the new value of the pixel is given by the formula F(Iᵥ)=Gᵥ Iᵥ+(1−Gᵥ) Mᵥ where Iᵥ is the initial value, Gᵥ is the filtration ratio and Mᵥ is the expected value, all for a given pixel v.

14. A method as claimed in claim 13, wherein the new value of the pixel is calculated iteratively.

15. A method as claimed in claim 1, wherein the image is two-dimensional.

16. A method as claimed in claim 1, wherein the image is multi-dimensional.

17. A method as claimed in claim 1, wherein the initial value of the pixel is pixel raw value.

18. A method as claimed in claim 1, wherein the image is acquired in medical imaging.

19. A method as claimed in claim 18, wherein the medical imaging comprises nuclear imaging.
